(19) United States
(12) Patent Application Publication
(10) Pub. No.: US 2003/0178860 A1
(43) Pub. Date: Sep. 25, 2003

(54) Security seal

(76) Inventors: Gareth William Thomas, Eaglescliffe (GB); George Relton McMillan, Hartlepool (GB); David Austin Burt, Berkshire (GB)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 10/392,312

(22) Filed: Mar. 20, 2003

(30) Foreign Application Priority Data
Mar. 21, 2002 (EP) 02252042.3

(51) Int. Cl. G09F 3/03

(52) U.S. Cl. 292/307 A; 292/325; 24/16 R

(57) ABSTRACT

Security seals (1) are widely used to demonstrate the integrity of a closed container, truck, roll pallet, cage or box. Typically such security seals (21) are made from plastics material and comprise a strap (2) with a plug (5) at one end and a socket (4) at the other end. The socket includes a one-way lock so that when the security seal (1) is threaded through a locking point and the plug (5) inserted into the socket (4) the plus is locked irremovably into the socket. The only way that the security seal can subsequently be removed is by destroying it. Such a security seal (1) includes a recognisable sequence of indicia (20) extending along substantially the whole length of the strap portion (2). The presence of the recognisable sequence of indicia (20) along the length of the strap (2) make it almost impossible to cut such a strap (2) and reconnect the cut ends without disrupting the sequence of indicia (20) so that it is immediately evident that the security seal (1) has been tampered with.

### BACKGROUND OF THE INVENTION

Security seals are widely used to demonstrate the integrity of a closed container, truck, roll pallet, cage or box to demonstrate, for example, that they have not been opened during transit. Typically such security seals are made from plastics material and comprise a strap with a plug at one end and a socket at the other end. The socket includes a one-way lock. In this way, the security seal is threaded through a locking point and the plug inserted into the socket. The plug is then locked irremovably into the socket so that the only way in which the security seal can subsequently be removed is by destroying it. Typically the security seal includes a unique serial number so that it can be confirmed that the same seal is still present after transport as was applied before transport, and the security seal may include a flag portion to carry this serial number.

### SUMMARY OF THE INVENTION

Attempts are made to breach the security of such seals by, for example, cutting the strap portion of the seal to enable it to be removed and the container, or whatever, opened. Then, after replacing the security seal the cut ends of the security seal are adhered or welded together. Such tampering, particularly when heat welding is used, can be difficult to spot when the security seal is checked for integrity.

According to this invention such a security seal includes a recognisable sequence of indicia extending along substantially the whole length of the strap portion. The presence of the recognisable sequence of indicia along the length of the strap make it almost impossible to cut such a strap and reconnect the cut ends without disrupting the sequence of indicia so that it is immediately evident that the security seal has been tampered with.

Preferably the seal carries a recognisable sequence o individual indicia on opposite sides of the strap. In this case the indicia on opposite sides of the strap are preferably of different form thus, they may be of different typestyle and/or indicia on one side of the strap may be recessed whilst, on the other side they are raised, for example. The indicia may be “joined up” in the manner o handwriting or, alternatively, have the form of normal: printing. It is also preferred that any space between adjacent indicia on one side of the strap is locate directly opposite indicia on the opposite side of the stray so that, at no point, can a cut be made through the stray without cutting through indicia on one or other side of the strap. To further assist this it is convenient if the indicia on one side of the strap are in an “italic” font and so are sloping in one direction, whereas the indicia on the other side of the strap are either in a normal font o: are arranged to be inclined in the opposite direction. In this way the indicia on opposite sides of the stray certainly overlap one another and any spaces in between.

The recognisable sequence of indicia may be, for example, the letters of the alphabet arranged in alphabetical order along the length of the strap or may be formed by a continuous number sequence. The alphabet may be English or that of another language such as Greek or Russian. Where the indicia are formed by letters they mad even form a recongnisable long word such a: “supercalifragalisticexpealedotious” or even be arranged to form a well known phrase such as an advertising slogan. In one particular example the recognisable sequence of individual indicia are provided by intercalated upper and lower case indicia arranged in alphabetical order extending from one end of the strap to the other.

### BRIEF DESCRIPTION OF THE DRAWINGS

A particular example of as a security seal in accordance with this invention will now be described with reference to the accompanying drawings; in which:—

FIG. 1 is a front elevation;

FIG. 2 is a side elevation;

FIG. 3 is a partial schematic side elevation drawn to a larger scale; and,

FIG. 4 is a partial front and rear elevation showing how the indicia on opposite sides of the strap are offset from one another.

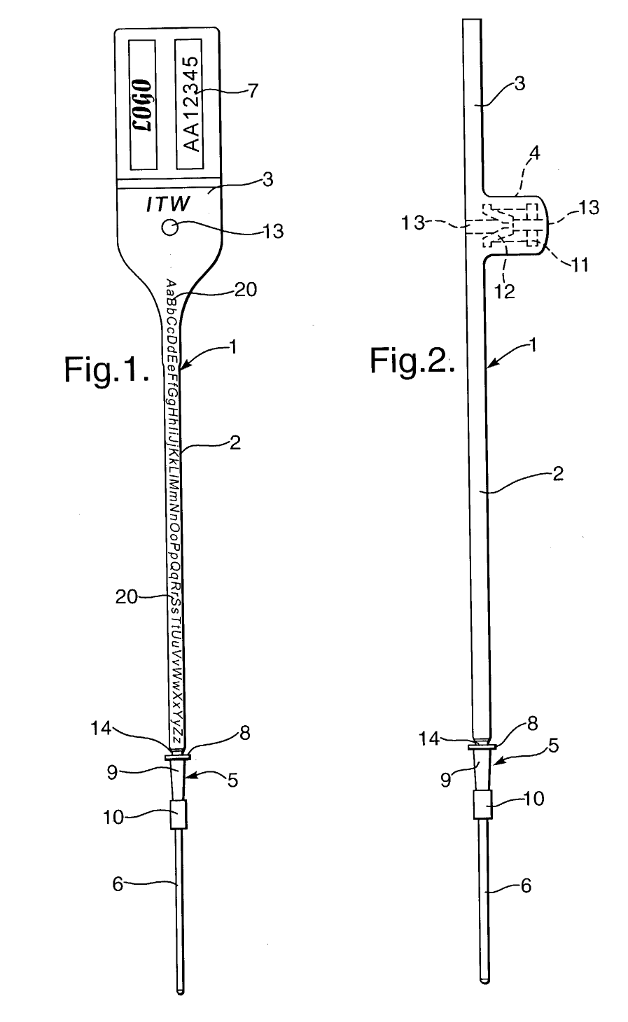

### DESCRIPTION OF PARTICULAR EMBODIMENT

The security seal 1 comprises a strap portion 2 having a flag 3 and socket 4 at one end and a plug 5 and tail 6 at the opposite end. The flag 3 carries a unique identification number 7 which may be in the form of a bar code and may also carry a logo, for example. The plug 5 includes a collar 8 a frusto-conical portion 9 and a locking spigot 10. The socket 4 includes an insert 11 having resilient locking fingers 12 and an aperture 13. Typically, the seal 1 is formed from high density polyethylene with the insert 11 formed by acetal and included in the seal 1 as part of an insert moulding operation.

To use the seal 1 the tail 6, plug portion 5 and strap 2 are threaded through a locking point and then the tail 6 inserted into the aperture 13. As the tail 6 is threaded through the aperture 13 and the plug, in particular the locking spigot 10 passes between the resilient fingers 12 until the collar 8 engages the face of the flag portion 3 which prevents the socket portion 5 being inserted any further. However, at this point, the resilient fingers 12 have closed behind the shoulder formed between the locking spigot 10 and the frusto-conical portion 9 to prevent withdrawal of the plug portion 5 from the socket 4. A weakened portion 14 of the strap 2 is provided immediately behind the collar 8. When the seal is subjected to undue strain attempting to remove the plug 5 from the socket 4 the seal fails at this weakened portion 14 rather than by releasing the plug 5 from the socket 4.

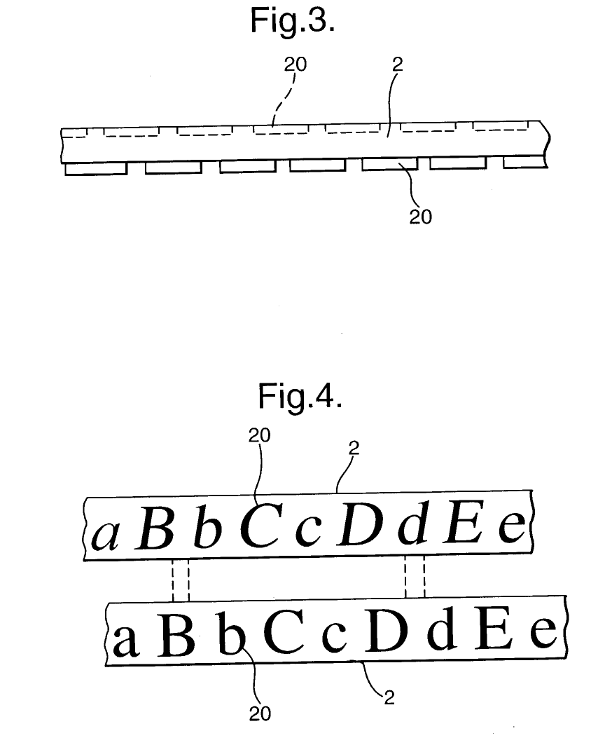

The seal is also provided with a recognisable sequence of individual indicia 20 along the length of the strap portion 2. In this example, indicia are provided on both sides of the strap portion 2 with the indicia on the front face being indented whilst those on the rear face project outwards, as shown in FIG. 3. Indicia 20 on the front face are also formed in an italic font, whereas the indicia on the rear face are formed in an upright font, as best shown in FIG. 4. The indicia on the front and rear faces are also off-set longitudinally from one another so that any space between adjacent indicia on the front face corresponds to the location of an indicia on the rear face, again shown in FIG. 4. In this way there is no portion of the strap that can be cut without the cut passing through indicia on at least one face. The recognisable sequence of indicia used in this example is an intercalated upper and lower case English language alphabet, with the alphabet starting at the end of the strap adjacent the socket 4 and the end of the alphabet being adjacent the weakened zone 13.

What I claim is:

1. In a security seal comprising a strap having a length and ends, a plug at one end of said strap and a socket at the other end of said strap;
the improvement wherein said security seal includes a recognisable sequence of indicia extending along substantially the whole said length of said strap.

2. The security seal of claim 1, wherein said seal carries a recognisable sequence of individual indicia on opposite sides of said strap.

3. The security seal of claim 2, wherein said indicia on opposite sides of said strap are of different form.

4. The security seal of claim 2, wherein said indicia on opposite sides of said strap are of different type style.

5. The security seal of claim 2, wherein which said indicia on one side of said strap are recessed and said indicia on another side of said strap are raised.

6. The security seal of claim 2, wherein space between adjacent indicia on one side of said strap is located directly opposite indicia on the opposite side of said strap whereby at no point can a cut be made through said strap without cutting through indicia.

7. The security seal of claim 1, wherein said recognisable sequence of indicia are the letters of the alphabet arranged in alphabetical order along the length of said strap.

8. The security seal of claim 7, wherein said recognisable sequence of individual indicia are provided by intercalated upper and lower case indicia arranged in alphabetical order extending from said one end of said strap to said other end of said strap.

9. The security seal of claim 6, wherein said recognisable sequence of indicia on both sides of said strip are the letters of the alphabet arranged in alphabetical order along the length of said strap.

10. The security seal of claim 6, wherein said recognisable sequence of individual indicia on both sides of said strip are provided by intercalated upper and lower case indicia arranged in alphabetical order extending from said one end of said strap to said other end of said strap.
